(19) United States
(12) Patent Application Publication
(10) Pub. No.: US 2014/0379668 A1
(43) Pub. Date: Dec. 25, 2014

(54) AUTOMATED PUBLISHED DATA MONITORING SYSTEM

(71) Applicant: Microsoft Corporation, Redmond, WA (US)

(72) Inventors: Alok K. Sinha, Sammamish, WA (US); Gautam Swaminathan, Kirkland, WA (US); Andrew Cherry, Everett, WA (US)

(21) Appl. No.: 13/924,453

(22) Filed: Jun. 21, 2013

(51) Int. Cl. G06F 17/30

(52) U.S. Cl. CPC G06F 17/30371
USPC 707/690

(57) ABSTRACT

An automated published data monitoring system implements a content validation service capable of validating published data in accordance with programmable criteria. A root data location is provided and validation of such data includes crawling a hierarchical organization of additional data. Deserializers are specific to identified collections of data and deserialize data into strongly typed data structures that are programmatically validatable. Deserializers register themselves to handle collections of data identified based upon the location and domain of such data. Additionally, validators are specific to types of data structures and programmatically validate such data structures including validating their type and their correctness, the latter as compared to statically or dynamically defined limits. Validators register themselves to handle specified types of data structures originating from specific data collections. Content can be validated in accordance with either a depth-first or breadth-first validation.

### BACKGROUND

The ever-increasing availability of network connections has rendered ubiquitous the delivery of content over such network connections. For example, network communicational connections between personal computing devices and other computing devices, such as through the ubiquitous Internet and World Wide Web, can be utilized to both publish and retrieve content on a global scale. Additionally, the linking mechanisms acting as the foundation of, for example, the World Wide Web, can enable published content to be republished and repackaged in a myriad of ways. For example, one webpage can include selected content of another webpage merely by providing a pointer to such another webpage, such as in the form of a hypertext link.

When repackaging and republishing content, however, the author utilizing such content inherently accepts and republishes any errors present in the original content. For example, an author publishing a review of a new tablet computing device can include images of such a tablet computing device to render their review more visually appealing. Rather than obtaining such images themselves, the author can, instead, simply insert links, or pointers, to such images as they would be published by, for example, the manufacturer of the tablet computing device. Should the images being published by the manufacture of the tablet computing device contain errors, such as by improperly showing the wrong device, then the review pointing to such published images will also contain the wrong images.

Consequently, it can be desirable for both the publishers of content that is being republished, as well as the re-publishers of such content, to verify the content. Verifications can be as simple as verifying that the content is, actually, available. For example, content verification can include verifying that an image indicated as being stored in an identified location is, actually, stored at that location. Verifications can also be more complex, such as by verifying the correctness of published data as compared to known boundaries. For example, an author of an article could seek to verify that the byline of the article does not identify a date that is in the future, or does not identify a location that does not exist.

Because content often did not vary over short periods of time, content verification was performed by processes that relied on direct human interaction to perform such verification. For example, the content of typical websites can remain static for days, weeks or even months, thereby enabling such contents to be verified on human timescales. For content that was generated more quickly, and in a volume greater than could be verified on human timescales, automated content verification systems were limited to availability verification, whereby they could only verify that the content was, in fact, available, irrespective of its propriety or correctness. Increasingly, however, it is desirable to publish and republish real-time content, such as current stock prices, current weather conditions and forecasts, current news reports, and other like information that can change over very short periods of time. For such content, human verification is impractical, if not impossible, and automated verification verifying only its availability is insufficient to detect errors that can negatively impact the experience of users consuming such published, or republished content.

### SUMMARY

In one embodiment, an automated published data monitoring system can implement a content validation service that can validate published data in accordance with programmable criteria. The automated content validation service can accept, as input, one or more root data locations, and the automated content validation service can automatically crawl and validate the published data that is under such a root.

In another embodiment, the automated published data monitoring system can comprise deserializers that are specific to identified collections of data and which can deserialize the data into strongly typed data structures that can be programmatically validated. Deserializers can register themselves to handle collections of data that can be identified based upon the location and domain of such data.

In a further embodiment, the automated published data monitoring system can comprise validators that are specific to identified types of data structures and which can programmatically validate such data structures including validating their correctness, such as compared to statically or dynamically defined limits. Validators can register themselves to handle specified types of data structures originating from specific data collections, which can be identified based upon the location and domain of such data.

In a still further embodiment, content can be validated in accordance with either a depth-first validation of the data under an identified root data location or a breadth-first validation of that data. Should the validation fail, the reason for the failure can be individually identified, including by reference to identifying metadata, to aid corrective action. Validation results can be associated, not only with the specific data validated, but also with any data that links to such data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram illustrating an exemplary context within which an automated published data monitoring system can be implemented;

FIG. 2 is a block diagram illustrating an aspect of an exemplary automated published data monitoring system;

FIG. 3 is a block diagram illustrating another aspect of an exemplary automated published data monitoring system;

FIG. 4 is a flow diagram of an exemplary operation of an automated published data monitoring system;

FIG. 5 is a flow diagram of another exemplary operation of an automated published data monitoring system; and

FIG. 6 is a block diagram of an exemplary computing device.

### DETAILED DESCRIPTION

The following description relates to mechanisms for implementing an automated published data monitoring system that can implement a content validation service capable of validating published data in accordance with programmable criteria. The automated content validation service can accept, as input, one or more root data locations, and can automatically crawl and validate the published data that is under such a root. The automated published data monitoring system can comprise deserializers that are specific to identified collections of data and which can deserialize the data into strongly typed data structures that can be programmatically validated. Deserializers can register themselves to handle collections of data that can be identified based upon the location and domain of such data. Additionally, the automated published data monitoring system can comprise validators that are specific to identified types of data structures and which can programmatically validate such data structures including validating their correctness, such as compared to statically or dynamically defined limits. Validators can register themselves to handle specified types of data structures originating from specific data collections, which can be identified based upon the location and domain of such data. Content can be validated, by the content validation service, in accordance with either a depth-first validation of the data under an identified root data location or a breadth-first validation of that data. In either case, data that fails validation can be flagged both in and of itself and also in conjunction with any data that links to such data.

For purposes of illustration, the techniques described herein are directed to specific network environments and specific data consumption paradigms. In particular, the techniques described herein make reference to World Wide Web environments and to the utilization and republishing of content within the context of web-based applications or web-based user experiences. However, references to, and illustrations of, such environments and embodiments are strictly exemplary and are not intended to limit the mechanisms described to the specific examples provided. Indeed, the techniques described are applicable to any network-accessible data that can be consumed and republished.

Additionally, although not required, the description below will be in the general context of computer-executable instructions, such as program modules, being executed by one or more computing devices. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to a stand-alone computing device, as the mechanisms may also be practiced in distributed computing environments linked through a communications network. In a distributed computing environment, program modules may be located in both local and remote memory storage devices.

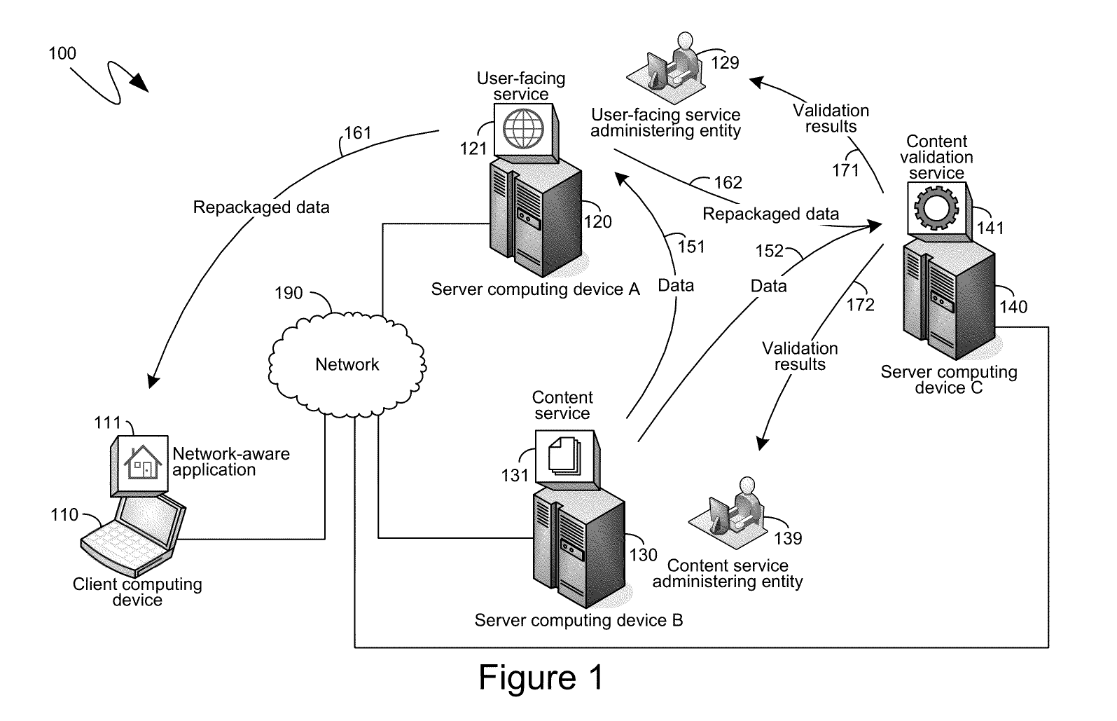

With reference to FIG. 1, an exemplary system 100 is illustrated, providing context for the descriptions below. Exemplary system 100 can be in the context of data and services being provided over a network, such as the network 190, by a user-facing service 121. The user-facing service 121 can, in one embodiment, be accessed by an appropriate network-aware application program, such as the exemplary network-aware application 111, that can execute on a client computing device, such as the client computing device 110. For example, the user-facing service 121 can be a website that can provide web-based applications or web-based user experiences to users over the network 190, where such users can utilize a web browser executing on their own computing devices, such as the client computing device 110, to perform various tasks, such as making travel arrangements, managing investments, reading and consuming news, weather, sports and other like information, and other like tasks. Consequently, the user-facing service 121 can be a website, or web service, which can consume content provided by other content providers, such as news organizations, financial reporting organizations, travel-centric entities, such as hotels, airlines and rental cars, and other like content providers, and can then repackage, or republish, such content into the repackaged data 161, which can then be consumed by a user utilizing a network-aware application, such as the network-aware application 111, executing on their own computing device, such as the client computing device 110.

The user-facing service 121 can obtain the data, which it then repackages and republishes into the repackaged data 161, from other content providers, such as the exemplary content service 131 which, in the exemplary system 100 of FIG. 1, is illustrated as executing on a server computing device 130 that can also be communicationally coupled to the network 190. Data 151, from the content service 131, can be obtained by the user-facing service 121, or otherwise referenced or linked-to thereby, and can, thereby, be republished as part of the repackaged data 161 that is provided by the user-facing service 121. Thus, if some of the data 151 is invalid, or not proper, such incorrectness can be passed along, by the user facing service 121, as part of the repackaged data 161. Consequently, in one embodiment, a content validation service, such as the exemplary content validation service 141, can validate the data being provided by the content service 131. The content validation service 141 can execute on a server computing device 140 that can also be communicationally coupled to the network 190, and, via such a communicational connection, the content validation service 141 can consume the data 152, which can be equivalent to the data 151 being republished by the user facing service 121, and can validate such data. Alternatively, or in addition, the content validation service 141 can consume the repackaged data 162, which can be equivalent to the repackaged data 161 being received by the end user, and can validate such data. When validating the data 152, the content validation service 141 can provide back-end functionality, enabling a publisher of data, such as the content service 131, to validate the data they publish, and take corrective action, prior to negatively impacting their clients, such as the user-facing service 121. In such an embodiment, the server computing device 140 can be co-located with the server computing device 130, and the content validation service 141 can be executed alongside content service 131. Conversely, when validating the repackaged data 162, the content validation service 141 can enable validation of the data “seen by the user”, which can be beneficial to the optimal operation of the user-facing service 121.

Once data is validated, validation results 171 and 172 can be provided to a user-facing services administering entity 129 or a content service administering entity 139, respectively. The content service administering entity 139 can, for example, in response to the validation results 172, correct any errors identified therein. Conversely, the user-facing services administering entity 129 can, for example, in response to the validation results 171, eliminate references to, or republishing of, data that was identified as being invalid.

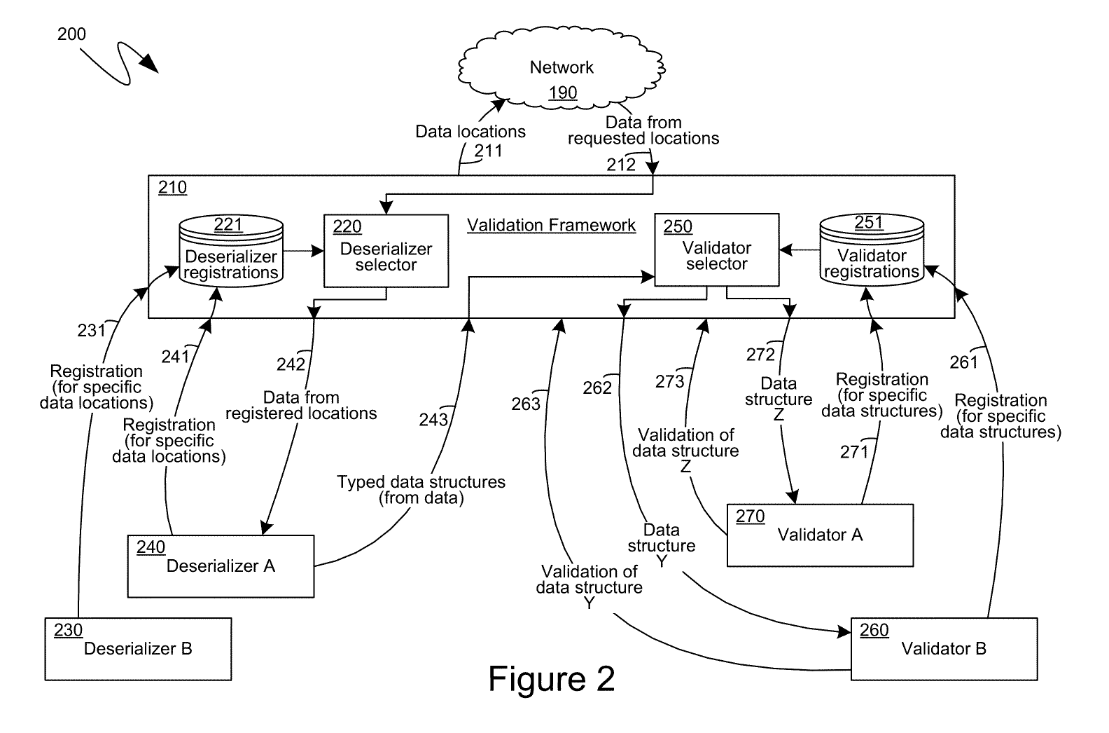

Turning to FIG. 2, the system 200 shown therein illustrates an exemplary series of components and operations of a content validation service, such as the exemplary content validation service 141 that was shown in FIG. 1. For clarity of illustration and description, the exemplary system 200 of FIG. 2 only shows a few instances of deserializer and validator components and only represents communications from the validation of the data of a single location. However, the described system is in no way intended to be so limited in scope. To the contrary, by componentizing the functionality of the deserializers and validators, such as in the manner described in detail herein, the described mechanisms can be implemented in a large scale to enable processing and validation of substantial quantities of data, including rapidly changing data and rapidly generated data. In such large scale implementations, activities and functions, which are described serially herein only for purposes of clarity, can be performed in parallel and asynchronously, further aiding in the aggregate efficiency of such a large-scale implementation. Nevertheless, for purposes of detailing operation of contemplated mechanisms, the system 200 of FIG. 2 illustrates a validation framework 210 to which can be input one or more locations of data, such as the data locations 211, which the validation framework 210 can use to request data from such locations over the network 190. Upon receiving the data 212 from the requested locations, the validation framework 210 can, initially, in one embodiment, utilize a deserializer selector 220 to select a deserializer to deserialize the data 212 from a specific requested location.

In one embodiment, one or more deserializers, such as the exemplary deserializers 230 and 240, can register themselves with the validation framework 210, informing the validation framework 210 of the set of data that such deserializers can deserialize. For example, in one embodiment, deserializers can, as part of registering with the validation framework 210, identify the data that such deserializers can deserialize based upon the location of such data. Such a location can be in the form of a Uniform Resource Locator (URL), or other like network data location identifier. Because a given deserializer may be capable of deserializing data from multiple different locations, the specification of data locations can be in a variable format, such as in the commonly utilized “regular expression” or “regex” format. Utilizing variable formats, a deserializer can register itself as the deserializer to be used for a range of locations, or a particular category of locations. Within the system 200 of FIG. 2, the exemplary deserializers 230 and 240 are illustrated as registering with the validation framework 210 via the communications 231 and 241, respectively.

In one embodiment, the validation framework 210 can retain such registrations, such as in a deserializer registration store 221 and can reference such a deserializer registration store 221 to identify a deserializer to use for data from a given location. More specifically, and as illustrated in FIG. 2, upon receiving a set of data 212 from a given location, a deserializer selector 220 can reference the deserializer registration store 221 and, in such a manner, identify a deserializer, such as one of the deserializers 230 and 240, to invoke to deserialize the data 212. In the exemplary system 200 of FIG. 2, the data 212 can be provided by the validation framework 210 to the deserializer 240, which can have been selected by the deserializer selector 220 based upon the registration information 241 provided by the deserializer 240 to the validation framework 210, in starting the deserializer registration store 221. The invocation of such a deserializer 240, by the validation framework 210, is illustrated by the communication 242, via which the validation framework 210 can provide the data 212 to the deserializer 240. In response, the deserializer 240 can return, to the validation framework 210, one or more strongly typed data structures 243 that the deserializer 240 can have obtained from the data provided via the communication 242.

Often, data to be validated can be in the form of a string of textual data that can be difficult to validate programmatically. For example, and as will be recognized by those skilled in the art, a textual string, such as “123”, can be merely a representation of alphanumeric characters, while a numerical data type, such as the “integer” data type, can result in “123” being interpreted as a numerical value of one hundred twenty-three that is greater than the numerical value one hundred twenty-two and less than the numerical value one hundred twenty-four. When expressed as a numerical data type, such a value can be validated based upon its relationship to static or dynamic thresholds, such as in the manner described in detail above. Consequently, in one embodiment, a deserializer, such as the deserializer 240, can deserialize data by converting appropriate portions of such data from mere textual strings into strongly typed data structures, such as the strongly typed data structures 243, which can then be validated programmatically.

The deserialization performed by a deserializer, such as the deserializer 240, can be dependent upon the format of the data that is being validated. For example, weather data can be provided in a string format that lists a high temperature first, followed by a comma, then followed by a low-temperature, and both of those temperatures can be provided to the nearest whole degree Fahrenheit. A deserializer for such data would understand such a format and would convert the characters preceding the comma to an integer data structure identified as a high temperature, and would convert the characters following the comma to a different integer data structure identified as a low-temperature. Such a deserializer can have been written specifically for such data in such a format and can register itself as being capable of handling such data in such a format by identifying itself as a deserializer that is associated with, or registered for, handling the data provided from a specific location that is known to provide weather data in such a format. For example, the deserializer can have been written by the same entity creating and maintaining the mechanisms for generating the weather data in such a format.

Once the strongly typed data structures 243 are returned to the validation framework 210, the validation framework 210 can, in one embodiment, select a validator that can validate one or more of the strongly typed data structures 243. More specifically, in one embodiment, validators, such as the exemplary validators 260 and 270, shown in FIG. 2, can also register themselves with the validation framework 210. Each validator can, as part of such a registration, identify one or more specific data structure types, as obtained from one or more sources of data, that such a validator can validate. The registration of the exemplary validators 260 and 270 is illustrated in the system 200 of FIG. 2 via the communications 261 and 271, respectively. The validation framework 210 can retain such validator registrations in a validator registration store 251.

A validator selector 250 can then utilize the validator registration store 251 to select one or more validators to validate the strongly typed data structures 243 returned by a deserializer, such as the exemplary deserializer 240 of FIG. 2. In one embodiment, data from a data location can be deserialized using only a single deserializer, such as one that specifically registered with the validation framework 210 to be associated with such a specific data location, but such deserialized data can then be validated by multiple different validators, such as validators that registered with the validation framework 210 to be associated with different ones of the data types of the data received from such a specific data location.

By way of example, financial data can be obtained from a financial data generating entity and weather data can be obtained from a weather data generating entity. One deserializer can deserialize the financial data, while another, different, deserializer can deserialize the weather data. Continuing the present example for illustrative purposes, each of those two deserializers can output, for example, two different types of data structures, namely floating point data structures and alphanumeric string data structures. In the case of the weather data, the floating-point data structures can be temperatures and the alphanumeric string data structures can be the names of the geographic locations reporting such temperatures. By contrast, in the case of the financial data, the floating-point data structures can be stock prices and the alphanumeric string data structures can be the names of public companies. Consequently, different validators can be appropriate for validating even the same type of data structures. For example, a validator validating the floating-point data structures generated by the deserializer deserializing the weather data can be directed to verifying, for example, that the temperatures reported are within a reasonable temperature range, such as between negative one hundred and positive one hundred and fifty degrees Fahrenheit. By contrast, a validator validating the floating-point data structures generated by the deserializer deserializing the financial data can be directed to verifying, for example, that the percentage change indicated is actually the result of dividing the dollar amount of the change of a stock price by the dollar amount of that stock's previous closing price. Consequently, while both validators can be directed to validating data structures that are of a floating-point type, the validator validating weather data structures of a floating-point type can be different than the validator validating financial data structures that can also be of a floating-point type.

The validator selector 250, in selecting one or more of the validators, such as the validators 260 and 270, can select validators that both are registered as validating the relevant type of data structure, as well as validators that are registered as validating that type of data structure from a specific data location, or other like identifier of the kind of data. In the embodiment illustrated by the system 200 of FIG. 2, the validator selector 250 can direct at least some of the strongly typed data structures 243, from the deserializer 240, to the validator 260, as illustrated by the communication 262, while also directing at least some others of the strongly typed data structures 243 to the validator 270, as illustrated by the communication 272. The validators 260 and 270, therefore, can have registered to handle those types of data structures, as sourced from the same data locations that the deserializer 240 registered as being able to deserialize.

In response to being invoked to validate one or more data structures, the validators, such as the validators 260 and 270, can validate such data structures and can return the results, such as via the communications 263 and 273, respectively, to the validation framework 210. As indicated previously, in one embodiment, validation of data structures can comprise a comparison of the data contained in those data structures to predetermined boundaries. For example, in the example provided above, a validator of temperature data can validate that the temperature data is greater than some established minimum temperature and less than some established maximum temperature. In another embodiment, validation of data structures can comprise more programmatic analysis of those data structures. For example, a validator of temperature data can validate, not only that the temperature data comprises values between predefined, static thresholds, but also that the value specified as the high temperature actually exceeds, or at the very least is equal to, the value specified as the low temperature.

If a validation fails, a validator can provide, such as to the validation framework 210, an indication of such a failure. In one embodiment, such an indication can detail the data that failed validation, including with reference to metadata, and the reason why such data was deemed, by the validator, to have failed validation. For example, a weather data validator can be designed to detect specific error values in reported temperature. Should such a weather data validator detect a temperature value of negative 65,536 degrees, such a validator could indicate a validation failure and specifically identify the data, such as the erroneous temperature value, that caused the validation to fail. In identifying the data that failed, a validator can reference metadata or metainformation. In the above example, if the exemplary erroneous temperature value of negative 65,536 degrees was part of a data structure reporting a weather forecast for tomorrow for a given city, then the validator could identify, not just the erroneous temperature value, but could also identify that it is tomorrow's forecast temperature for that specific city that is causing the validation failure.

In one embodiment, validators, like the above-described deserializers, can be generated by the same entity that supports the publishing of the data being validated. Consequently, validators can be designed and implemented with specific error correcting instructions, such as those that based on implementation details. Returning to the above example, entities implementing the provision and publishing of weather data can be aware that, for example, failed weather temperature sensors typically report a value of negative 65,536 degrees. Consequently, in implementing a validator for such weather data, not only could such a validator check for the above described conditions, and accordingly validate weather data, but such a validator could also specifically check for, for example, a temperature value of negative 65,536 degrees, and, in such a case, rather than generically reporting an error, such a validator could be designed to specifically report that the temperature sensor associated with such a geographic reporting station is experiencing an known error. Such troubleshooting information can aid in the correction of the validation issues detected by the validators.

As indicated previously, the data being validated can be generated and published in real time, or at very frequent time intervals, and there can also be a large quantity of such data. Often, as will be recognized by those skilled in the art, data is published, or provided, by reference to a hierarchical data storage format in which data locations are identified by a path through one or more layers of increasingly specific containers. A most general container is typically referred to as the “root node”, and the location, or identification, of data is typically provided in terms of a path through other containers originating from such a root node. For example, URLs are typically provided in a form of: domain.com/container/subcontainer/datalocation, where the identification of the domain can be a root node, which can comprise multiple containers, one of which is identified by the “container” portion of the above exemplary URL. Such a container can then contain sub-containers, one of which is identified by the “subcontainer” portion of the above exemplary URL. Alternatively, the “container” portion of the above exemplary URL can be identified as a root node, such that all of the sub-containers contained in such a container would be considered to be part of such a root.

Another hierarchical organization of data can be based, not on the manner in which the data is stored, but in the manner in which data is referenced. For example, a news article can comprise links, or pointers, to prior articles, or other articles of interest. Such a news article can be considered a root node, and each of the articles to which it links can be considered “children” of such a root node. Each linked article can, in turn, link to further articles that can, again, have some relationship to the article from which they are linked. In such an instance, the original article can be identified as a root node, and any articles to which it links can be analogous to the containers of the hierarchical storage organization described above. Similarly, any articles linked to by those second-level articles can be analogous to the sub-containers of the hierarchical storage organization described above. Consequently, as utilized herein, the terms “root node” and “root location” mean a starting point from which further conceptual or storage layers can be accessed in a recursive manner.

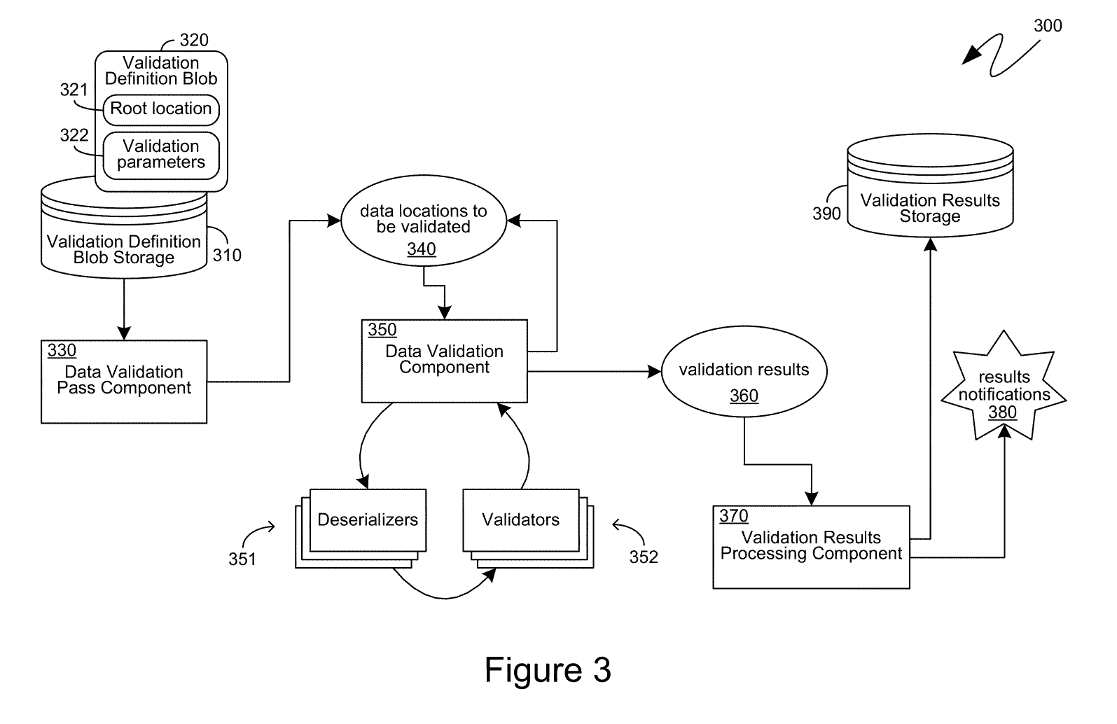

In one embodiment, to provide data validation for large quantities of published data, which can often change quickly, a content validation service can receive, as input, an identification of a root node, and the content validation service can then cycle through all of the containers and sub-containers under the umbrella of such a root node, identifying and obtaining the published data available therefrom, validating it, and returning the validation results. Turning to FIG. 3, the system 300 shown therein illustrates exemplary mechanisms for performing such a data validation crawl. As illustrated in the system 300, a validation definition blob storage 310 can comprise validation definition blobs, such as the exemplary validation definition blob 320, which can specify a collection of data to be validated, and can also provide validation parameters. For example, the exemplary validation definition blobs 320 can comprise an indicator of one or more root locations 321 from which a data validation crawl is to commence, validating all of the data that is hierarchically lower, and proceeding from, such one or more root locations 321. Additionally, a validation definition blob can comprise validation parameters, such as the exemplary validation parameters 322 of the exemplary validation definition blob 320. Such validation parameters 322 can specify how often a validation is to be performed on the data, the manner in which such a validation is to be performed, and other like validation parameters.

Entities that publish data, and seek to have such data validated, can generate validation definition blobs, such as the exemplary validation definition blob 320, or, alternatively, have them generated for such entities, and then such blobs can be provided to the data validation service, which can store them in the validation definition blob storage 310. Entities that consume, and republish, published data can, likewise, submit validation definition blobs, such as the exemplary validation definition blob 320, which can also be stored in the validation definition blob storage 310. In one embodiment, a data validation pass component 330 can obtain validation definition blobs from the validation definition blob storage 310 and can initiate a validation pass through the data identified thereby. Such a data validation pass component 330 can initiate validation passes based upon any number of criteria including, for example, a frequency specified within validation definition blobs, an order in which such validation definitions blobs were received, a priority assigned to such validation definition blobs as stored in the validation definition blob storage 310 and other like criteria. Once the data validation pass component 330 selects a blob on which a data validation pass is to be performed, the data validation pass component 330 can populate a collection of data locations to be validated 340 and can initiate a data validation component 350 to validate the data available from such locations.

In one embodiment, the data validation pass component 330 can extract the one or more root locations 321 from the validation definition blob 320 and can commence the data validation pass with such one or more root locations 321 in the data locations to be validated 340. The data validation component 350 can detect the presence of a new data location to be validated, from among the data locations to be validated 340, and can commence validation of such a location. As part of such a validation, the data validation component 350 can obtain data from the location identified, and can provide such data one or more of the deserializers 351. As indicated previously, a specific deserializer, from among the deserializers 351, can be selected based upon the location of the data and how such deserializers 351 registered themselves. After the data has been deserialized, one or more of the validators 352 can be invoked to validate such deserialized data. As detailed above, those of the validators 352 that are invoked can be selected based upon the information with which they registered themselves. As also indicated previously, the data validators can provide validation results, which the data validation component 350 can provide as the validation results 360. A validation results processing component 370 can detect such validation results 360, and can, optionally, store such validation results in a validation results storage 390. The validation results processing component 370 can, optionally, also provide results notifications 380, such as to entities that are capable of correcting, or rendering moot, one or more of the validation errors identified.

Typically, as indicated, the root location 321 that the data validation pass component 330 puts in the data locations to be validated 340 can comprise one or more hierarchically lower layers of data. For example, in a hierarchical storage context, a root node can comprise one or more containers of data that can comprise further data, or still further sub-containers of data. As another example, in a logical hierarchical organization, a root node can comprise pointers to one or more other data which can, in turn, comprise further pointers to still other data. In one embodiment, as part of the operation of a validator, such as one or more of the validators 352, a validator can identify hierarchically lower layers of data. For example, a deserializer, such as one of the deserializers 351, can identify a textual string as a link to other data. As part of the deserialization of the data obtained by the data validation component, such a link to other data can be deserialized into a data structure having a link type associated with it, which can then be processed by a validator, from among the validators 352, registered to process link types from the source of the data that was obtained by the data validation component 350. Such a validator can, as part of the validation process, identify and verify the link to such other data, and can, should such a link be verified, provide such a link to the data validation component 350 to put into the data locations to be validated 340. The data validation component 350 can then proceed to obtain such linked-to data and one or more of the deserializers 351 and the validators 352 can be invoked, by the data validation component 350, to validate such linked-to data in accordance with the methods already described.

In one embodiment, a “breadth first” validation of data can be performed where each hierarchical layer of data is validated before proceeding to a lower hierarchical layer of data. For example, returning to the above example of a root node comprising links to other data, each of such links can be deserialized, such as by one or more of the deserializers 351, and then validated by one or more of the validators 352. Thus, as part of a validation of the root node, as indicated, the validators 352 can provide each such link to the data validation component 350, which can put each such link in the data locations to be validated 340. For ease of reference, such links will be referred to as “first level” links. Subsequently, upon completing the validation of the root node, the data validation component 350 can reference the data locations to be validated 340 and can select a first one of the “first level” links. To provide an illustrative example, the data referenced by such a first one of the “first level” links can, itself, comprise links to still further data that can be considered to be hierarchically lower then the data now being validated. For ease of reference, such links will be referred to as “second level” links. As part of a validation of the data identified by the first one of the “first level” links, one or more of the validators 352 can provide the “second level” links, which were found in the data identified by the first one of the “first level” links, to the data validation component 350. The data validation component 350, in putting those “second level” links into the data locations to be validated 340, can do so in such a manner that the data identified by such “second level” links will not be validated until the data identified by all of the “first level” links, which were previously added to the data locations to be validated 340, is validated. In such a manner, the data locations to be validated 340 can be organized in terms of hierarchical layers, and the data referenced by one hierarchical layer can be validated prior to the validation of any of the data referenced by a lower hierarchical later. In such a manner, a “breadth first” validation of data can be performed.

In an alternative embodiment, a “depth first” validation of data can be performed where, in order for any data to be validated, all of the data linked to by such data can first be validated. For example, returning to the above example of a root node comprising one or more “first level” links, in order for the root node to be validated, the data linked-to by each of the “first level” links can first be validated. Thus, in such an alternative embodiment, upon processing one of such “first level” links, one or more of the validators 352 can provide that “first level” link to the data validation component 350. The data validation component 350 can, instead of queuing up such a link in the data locations to be validated 340 can, instead, initiate validation of the data identified by such a “first level” link right away. More specifically, the data validation component 350 can obtain the data identified by such a “first level” link and can then invoke another instance of one or more of the deserializers 351 and the validators 352 to deserialize and then validate such data. If the data identified by such a “first level” link itself comprises links, namely one or more of the above referenced “second level” links, then an appropriate one of the validators 352 can provide such “second level” links to the data validation component 350, which can, in turn, initiate validation of the data identified by such “second level” links right away by, again, invoking still other instances of one or more of the deserializers 351 and the validators 352 to deserialize and validate that data. Processing can proceed in such an iterative manner until data is reached that does not comprise links to other data. Processing can then proceed back “up”, with the completion of the validation of each data enabling the further completion and validation of the hierarchically higher data.

In one embodiment, in such a “depth first” validation, the validation results of any data can include the validation results of data linked to by such data, and so on, hierarchically. Thus, for example, in such an embodiment, data can fail validation by linking to data that failed validation, and a validation error indicating the reason for such a failure, such as a link to data that has failed validation, can provide sufficient information to cure such a validation failure in one of at least two ways. In particular, such a validation failure can be cured by correcting the failed data itself or by removing the link to failed data in hierarchically higher data.

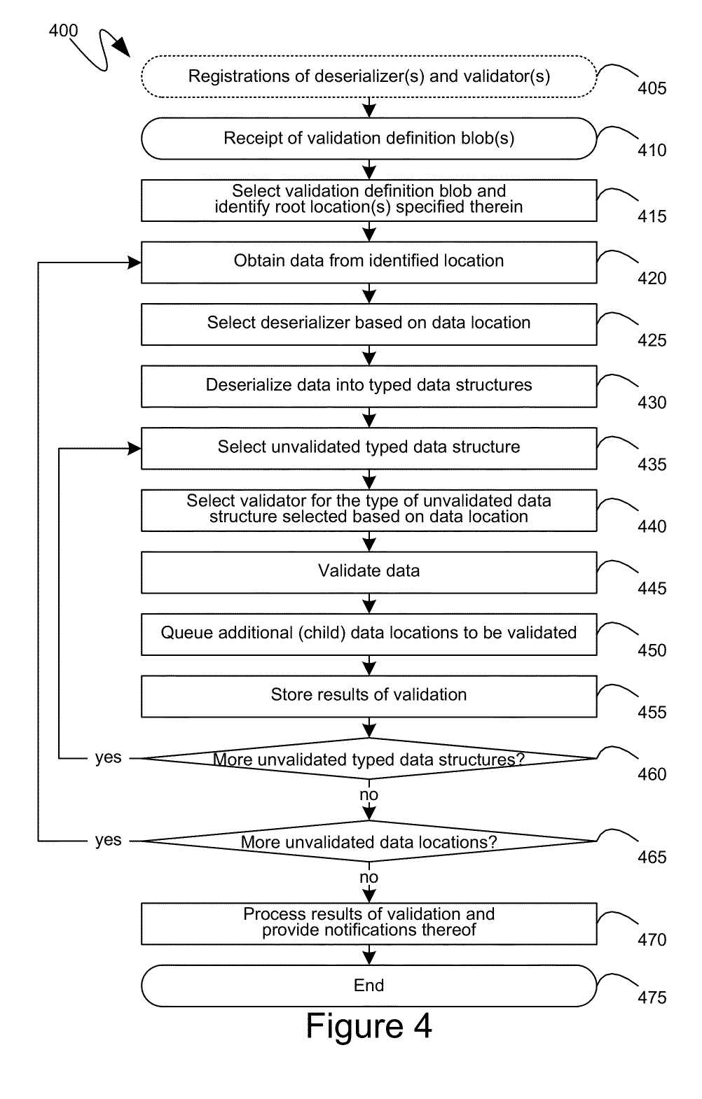

Turning to FIG. 4, the flow diagram 400 shown therein illustrates an exemplary series of steps that can be performed as part of a “breadth first” validation of data that has been published or republished. As a pre-condition, and as illustrated by step 405, one or more deserializers and one or more validators can register themselves, such as in the manner described in detail above. To illustrate that such is a pre-condition, and not an explicit step of a repeatable workflow, step 405 is shown with dashed lines in the flow diagram 400 of FIG. 4. Initially, at step 410, as described previously, validation can commence based upon validation definition blobs, such as validation definition blobs that can be provided by entities seeking to have some data validated.

Subsequently, at step 415, validation can proceed with the selection of a validation definition blob, from among those received at step 410, and the obtaining of one or more root locations of data from such a blob. Processing can then proceed with step 420, where the data from an identified location, such as the root location that was identified at step 415, can be obtained. Based upon the location of such data, or other identifying information, and based upon the information provided when deserializers registered themselves, a deserializer can be selected at step 425. In one embodiment, if a deserializer for the specific data obtained at step 420 cannot be identified, one or more default deserializers can be selected, at step 425, that can deserialize the data in accordance with a generic deserialization. The deserializer selected at step 425 can then proceed to deserialize the data into strongly typed data structures at step 430, such as in the manner described in detail above.

One of the strongly typed data structures, generated as part of the deserialization process at step 430, which has not yet been validated, can be selected at step 435. Subsequently, at step 440, one or more validators can be selected to validate such a strongly typed data structure. As indicated previously, the selection of a validator, at step 440, can be based on the information provided by such a validator when the validator registered itself, information which can include the type of data structure that the validator is designed to validate, and an identification of the data, such as by its source, or location, that the validator is designed to validate. The validation of data, by the validator selected at step 440, can proceed at step 445, such as in the manner described in detail above.

As part of the validation of data, one or more validators can identify hierarchically lower data, such as data that is linked to by the data currently being validated. As indicated previously, such hierarchically lower data or “child” data can be data that is linked to by the data currently being validated, or data that is stored in containers that are, themselves, stored within a container containing the data currently being validated. The locations of such hierarchically lower data can be queued, at step 450, for future validation. Subsequently, at step 455, the results of the validation of the strongly typed data structure that was selected at step 435 can be stored.

At step 460, a determination can be made as to whether there are any further strongly typed data structures, as generated by step 430, that have not yet been validated. If, at step 460, it is determined that there are further strongly typed data structures that have not yet been validated, processing can return to step 435 and another un-validated strongly typed data structure can be selected. As will be recognized by those skilled in the art, step 460 implies validation in a serial manner, such that validation of one strongly typed data structure is completed prior to proceeding with the validation of a subsequent strongly typed data structure. It can, however, be more efficient to perform validation of all of the strongly typed data structures of step 430 in parallel, in which case an explicit looping mechanism, such as that provided by step 460, is unnecessary. The illustration, in FIG. 4, of step 460, is only intended as a visual indicator of the validation of multiple strongly typed data structures, irrespective of whether such validation occurs in serial or in parallel.

Proceeding with step 465, if there is additional data, such as from locations that were queued at step 450, then processing can return to step 420 and the above-described steps can be repeated for such additional data. If, at step 465, is determined that no additional data remains to be validated, then processing can proceed with step 420 and the results of the validation of the data can be processed and, in one embodiment, appropriate notifications can be provided thereof. More specifically, and as indicated previously, the notifications that can be provided, at step 470, can include an indication of validation success or failure, an identification of why validation failed, and potentially additional information that can be specific to particular types of validations, or particular data contexts. The relevant processing can then end at step 475.

Although specifically illustrated in the exemplary flow diagram 400 of FIG. 4 as occurring after completion of all of the validation steps associated with a specified root location, the processing of validation results and the provision of notification at step 470 can be performed in parallel with others of previously described steps. Thus, for example, step 470 could be equally performed after step 445, thereby enabling the reporting of validation results as such results are determined by the validation step 445, irrespective of whether additional validations remain to be performed. In such an embodiment, validation results could be processed, and notifications provided, even while validation of other data structures from the same location remained ongoing.

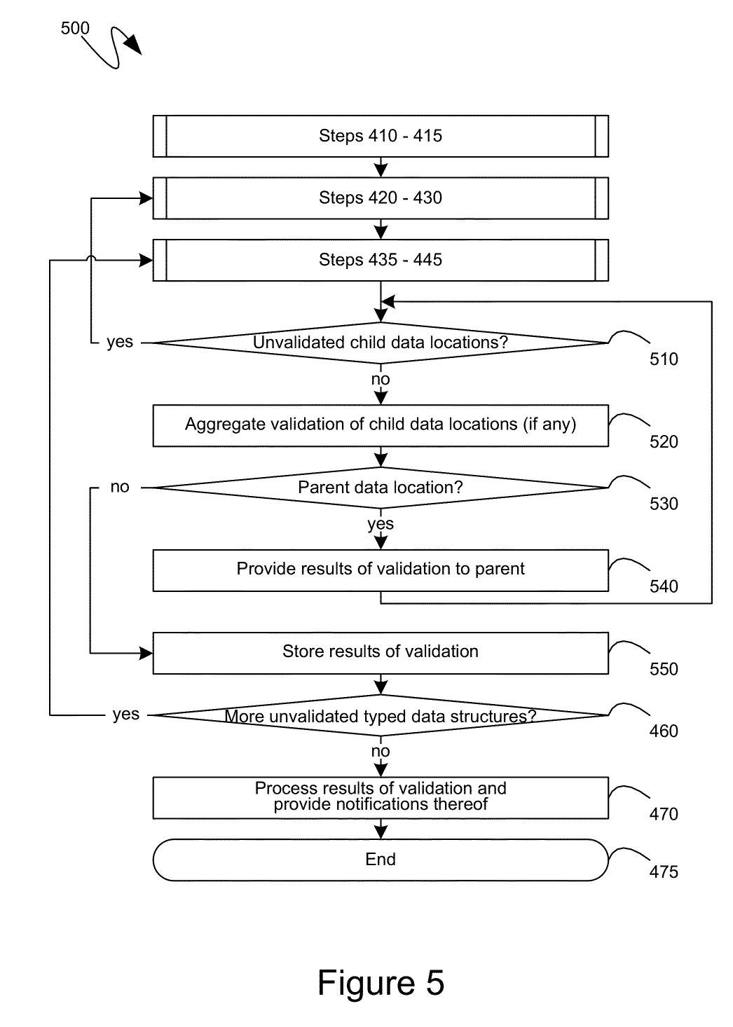

Turning to FIG. 5, the flow diagram 500 shown therein illustrates an exemplary series of steps that can be performed as part of a “depth first” validation of published data. The flow diagram 500 of FIG. 5 can comprise steps 410 through 445 that were described in detail above. Subsequently, following the validation of data, at step 445, processing can proceed with the determination of whether there are any hierarchically lower data locations that have not yet been validated. More specifically, and as indicated above, as part of the validation, at step 445, hierarchically lower data can be identified. For example, the data being validated, at step 445, can link to other data. Such links can be identified, as part of the validation, at step 445, and, subsequently, at step 510, a determination can be made that such links include hierarchically lower data that has not yet been validated. Processing can then proceed with step 420, where one of such hierarchically lower data is obtained and validated in the manner described in detail above in connection with steps 420 through 445. As will be recognized by those skilled in the art, the processing of such hierarchically lower data can be performed in a recursive manner until a hierarchically lowest layer of data is reached, having no links to subservient data.

If, at step 510, it is determined that the data currently being validated is at a lowest hierarchical level, such that is no hierarchically lower data, or, alternatively, if it is determined, at step 510, that any hierarchically lower data has already been validated, then processing can proceed with step 520, and the validation results of such hierarchically lower data, if there was any, can be aggregated. As indicated previously, in one embodiment, a “depth first” validation of data can entail incorporating, or aggregating, into the validation of a hierarchically higher level of data, any validation successes or failures of hierarchically lower data. For example, data linking to other data can be identified as failing validation if such other data has failed validation. Such an aggregation, or incorporation, can be performed at step 520. Subsequently, at step 530, a determination can be made as to whether there is any any hierarchically higher data whose validation is still in process. If, at step 530, it is determined that there is hierarchically higher data that is in the process of being validated, then the results of the current validation can be provided to the processes performing the validation of such hierarchically higher data, and processing can return to such processes in a recursive manner, with such processes then proceeding with the performance of step 510. Conversely, if, at step 530, it is determined that there is no hierarchically higher data, them the results of the validation can be stored, at step 550, and processing can proceed with steps 460 through 475, described in detail above. As indicated previously, step 460 is shown to provide visual representation of the validation of multiple strongly typed data structures, and is not intended to limit such validation to serial or parallel processes.

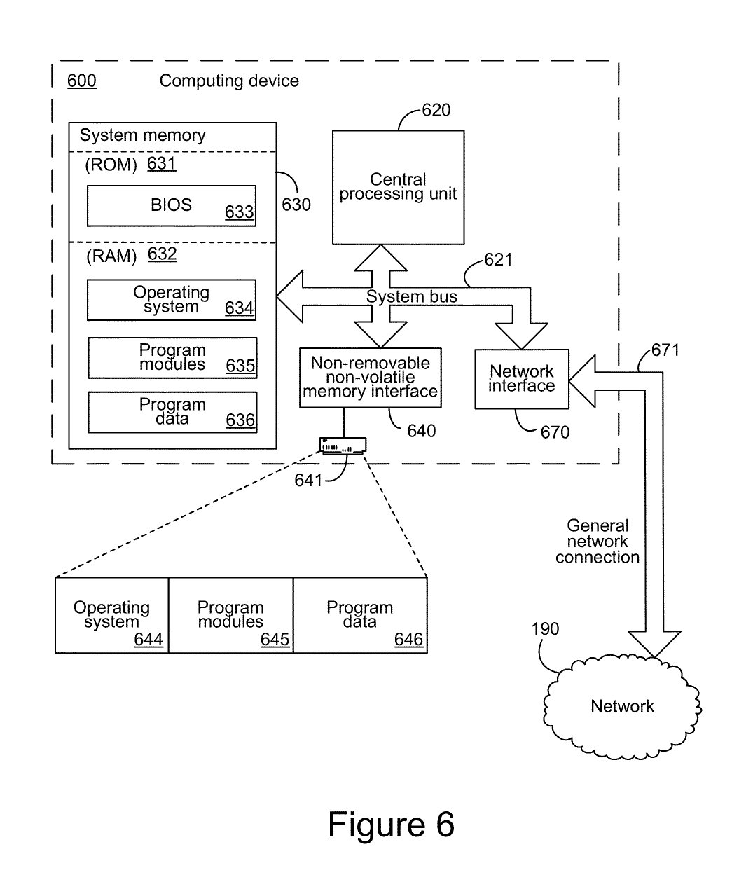

Turning to FIG. 6, an exemplary computing device 600 is illustrated, comprising, in part, hardware elements that can be utilized in performing and implementing the above described mechanisms. The exemplary computing device 600 can include, but is not limited to, one or more central processing units (CPUs) 620, a system memory 630 and a system bus 621 that couples various system components including the system memory to the processing unit 620. The system bus 621 may be any of several types of bus structures including a memory bus or memory controller, a peripheral bus, and a local bus using any of a variety of bus architectures. Depending on the specific physical implementation, one or more of the CPUs 620, the system memory 630 and other components of the computing device 600 can be physically co-located, such as on a single chip. In such a case, some or all of the system bus 621 can be nothing more than silicon pathways within a single chip structure and its illustration in FIG. 6 can be nothing more than notational convenience for the purpose of illustration.

The computing device 600 also typically includes computer readable media, which can include any available media that can be accessed by computing device 600. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 600. Computer storage media, however, does not include communication media. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

When using communication media, the computing device 600 may operate in a networked environment via logical connections to one or more remote computers. The logical connection depicted in FIG. 6 is a general network connection 671 to the network 190 described previously. The network 190 to which the exemplary computing device 600 is communicationally coupled can be a local area network (LAN), a wide area network (WAN) such as the Internet, or other networks. The computing device 600 is connected to the general network connection 671 through a network interface or adapter 670, which is, in turn, connected to the system bus 621. In a networked environment, program modules depicted relative to the computing device 600, or portions or peripherals thereof, may be stored in the memory of one or more other computing devices that are communicatively coupled to the computing device 600 through the general network connection 671. It will be appreciated that the network connections shown are exemplary and other means of establishing a communications link between computing devices may be used.

Among computer storage media, the system memory 630 comprises computer storage media in the form of volatile and/or nonvolatile memory, including Read Only Memory (ROM) 631 and Random Access Memory (RAM) 632. A Basic Input/Output System 633 (BIOS), containing, among other things, code for booting the computing device 600, is typically stored in ROM 631. RAM 632 typically contains data and/or program modules that are immediately accessible to and/or presently being operated on by processing unit 620. By way of example, and not limitation, FIG. 6 illustrates operating system 634, other program modules 635, and program data 636.

The computing device 600 may also include other removable/non-removable, volatile/nonvolatile computer storage media. By way of example only, FIG. 6 illustrates a hard disk drive 641 that reads from or writes to non-removable, nonvolatile media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640.

The drives and their associated computer storage media discussed above and illustrated in FIG. 6, provide storage of computer readable instructions, data structures, program modules and other data for the computing device 600. In FIG. 6, for example, hard disk drive 641 is illustrated as storing operating system 644, other program modules 645, and program data 646. These components can either be the same as or different from operating system 634, other program modules 635 and program data 636. Operating system 644, other program modules 645 and program data 646 are given different numbers here to illustrate that, at a minimum, they are different copies.

As can be seen from the above descriptions, automated mechanisms for verifying published data have been presented. In view of the many possible variations of the subject matter described herein, we claim as our invention all such embodiments as may come within the scope of the following claims and equivalents thereto.

We claim:

1. A method of validating data, the method comprising the steps of:
obtaining the data to be validated from a data location;
selecting a deserializer to deserialize the data;
deserializing the data to generate strongly typed data structures from the data;
selecting, based upon a type of each of the strongly typed data structures, one or more validators to validate the strongly typed data structures that were generated by the deserialization; and
validating the strongly typed data structures to generate validation results.

2. The method of claim 1, further comprising the steps of: receiving, from each of two or more deserializers, registration information specifying data that each deserializer, of the two or more deserializers, can deserialize, the specification of the data that each deserializer can deserialize being based on a location of the data; and wherein the selecting the deserializer comprises selecting from among the two or more deserializers based upon the registration information received from the two or more deserializers.

3. The method of claim 1, further comprising the steps of: receiving, from each of two or more validators, registration information specifying data that each validator, of the two or more validators, can validate, the specification of the data that each validator can validate being based on a location of the data and specifying a type of data; and wherein the selecting the one or more validators comprises selecting from among the two or more validators based upon the registration information received from the two or more validators.

4. The method of claim 1, wherein the validating the strongly typed data structures comprises comparing values of the strongly typed data structures to predefined thresholds.

5. The method of claim 1, wherein the validating the strongly typed data structures comprises comparing values of the strongly typed data structures to other values of the strongly typed data structures.

6. The method of claim 1, further comprising the steps of: identifying a hierarchically lower data, the hierarchically lower data either being linked to by the data or being located in a container at the data location; and queuing the identified hierarchically lower data for validation after validation of the data.

7. The method of claim 1, further comprising the steps of: identifying a hierarchically lower data, the hierarchically lower data either being linked to by the data or being located in a container at the data location; validating the hierarchically lower data before proceeding with validation of the data; and repeating recursively the identifying and validating of hierarchically lower data.

8. The method of claim 1, wherein the validation results associated with the data comprise validation results associated with hierarchically lower data.

9. The method of claim 1, further comprising the steps of: providing a notification of the validation results, the validation results comprising an identification of at least one element of the data that failed validation and a reason why the at least one element failed validation.

10. One or more computer-readable media comprising computer-executable instructions for validating data, the computer-executable instructions directed to steps comprising:
obtaining the data to be validated from a data location;
selecting a deserializer to deserialize the data;
deserializing the data to generate strongly typed data structures from the data;
selecting, based upon a type of each of the strongly typed data structures, one or more validators to validate the strongly typed data structures that were generated by the deserialization; and
validating the strongly typed data structures to generate validation results.

11. The computer-readable media of claim 10, comprising further computer-executable instructions for: receiving, from each of two or more deserializers, registration information specifying data that each deserializer, of the two or more deserializers, can deserialize, the specification of the data that each deserializer can deserialize being based on a location of the data; and wherein the computer-executable instructions for selecting the deserializer comprise computer-executable instructions for selecting from among the two or more deserializers based upon the registration information received from the two or more deserializers.

12. The computer-readable media of claim 10, comprising further computer-executable instructions for: receiving, from each of two or more validators, registration information specifying data that each validator, of the two or more validators, can validate, the specification of the data that each validator can validate being based on a location of the data and specifying a type of data; and wherein the computer-executable instructions for selecting the one or more validators comprise computer-executable instructions for selecting from among the two or more validators based upon the registration information received from the two or more validators.

13. The computer-readable media of claim 10, comprising further computer-executable instructions for: identifying a hierarchically lower data, the hierarchically lower data either being linked to by the data or being located in a container at the data location; and
queuing the identified hierarchically lower data for validation after validation of the data.

14. The computer-readable media of claim 10, comprising further computer-executable instructions for: identifying a hierarchically lower data, the hierarchically lower data either being linked to by the data or being located in a container at the data location; validating the hierarchically lower data before proceeding with validation of the data; and repeating recursively the identifying and validating of hierarchically lower data.

15. The computer-readable media of claim 10, wherein the validation results associated with the data comprise validation results associated with hierarchically lower data.

16. A system comprising:
at least one deserializer deserializing data provided to it, thereby generating strongly typed data structures from the data;
two or more validators, each validating a strongly typed data structure to generate validation results; and
a validation framework, the validation framework comprising:
a deserializer selector selecting one of the at least one deserializers to deserialize the data; and
a validator selector selecting based upon a type of each of the strongly typed data structures, at least one of the at two or more validators to validate the strongly typed data structures.

17. The system of claim 16, wherein the validation framework further comprises registration information from each of the at least one deserializer, the registration information specifying data that each of the at least one deserializer can deserialize, the specification of the data being based on a location of the data.

18. The system of claim 16, wherein the validation framework further comprises registration information from each of the two or more validators, the registration information specifying data that each validator, of the two or more validators, can validate, the specification of the data that each validator can validate being based on a location of the data and specifying a type of data.

19. The system of claim 16, further comprising:
a validation definition blob storage, comprising validation definition blobs, each validation definition blob comprising an identification of a data to be validated and validation parameters to be utilized in validating the identified data; and
a data validation pass component obtaining the validation definition blobs from the validation definition blob storage and initiating validation of the identified data.

20. The system of claim 16, further comprising: a validation results processing component generating results notifications comprising the validation results; wherein the validation results comprise an identification of at least one element of the data that failed validation and a reason why the at least one element failed validation.
